(19) United States
(12) Patent Application Publication
(10) Pub. No.: US 2025/0183828 A1
(43) Pub. Date: Jun. 5, 2025

(54) TUNING A SLIDING MODE OBSERVER FOR A PERMANENT MAGNET SYNCHRONOUS MOTOR

(71) Applicant: Microchip Technology Incorporated, Chandler, AZ (US)

(72) Inventors: Prosenjit Mondal, Baruipur (IN); Debraj Deb, Bangalore (IN)

(73) Assignee: Microchip Technology Incorporated, (omitted)

(21) Appl. No.: 18/966,003

(22) Filed: Dec. 2, 2024

(30) Foreign Application Priority Data
Dec. 1, 2023 (IN) 202341082000

(51) Int. Cl. H02P 21/13; H02P 21/00; H02P 21/18

(52) U.S. Cl. CPC H02P 21/13; H02P 21/0007; H02P 21/18

(57) ABSTRACT

A method is provided that may include receiving an identifier of a permanent magnet synchronous motor (PMSM), and mapping the identifier to electrical parameters of the PMSM. The method may include determining one or more coefficients of a sliding mode observer (SMO) based on the electrical parameters. The method may include providing the determined coefficients to the SMO to estimate the rotor position and speed of the PMSM.

### CROSS-REFERENCE TO RELATED APPLICATION

The present application claims priority to Indian Provisional Patent Application No. 202341082000, filed on Dec. 1, 2023, the contents of which are hereby incorporated by reference in their entirety.

### TECHNOLOGICAL FIELD

The present disclosure relates generally to permanent magnet synchronous motors and, in particular, to tuning a sliding mode observer to estimate rotor position and speed of a permanent magnet synchronous motor.

### BACKGROUND

Permanent magnet synchronous motors (PMSMs) are a popular choice among device manufacturers because of their high power density, fast dynamic response, and high efficiency in comparison with other motors in their category. With PMSMs, the rotor field speed is equal to the stator (armature) field speed (i.e., synchronous). The loss of synchronization between the rotor and stator fields can cause the motor to halt, and so knowing rotor position and speed is needed to avoid control failures in such motors.

Conventional approaches to determining position and speed of rotors include the use of encoders, such as resolver encoders, incremental ABZ encoders, absolute position encoders, and sin/cos encoders, but these increase costs and space requirements. Hall Effect sensors are sometimes used, but these increase costs and have low reliability. Three-phase motor terminal voltage sensing circuits can also be used, but these place a demand on the resources of the controller used to operate the motor. For example, a traditional control method involves driving the stator in a six-step process to generate torque. In such six-step control, a pair of windings is energized until the rotor reaches the next position, and then the next pair of windings is energized. Hall Effect sensors can be used to determine the rotor position to electronically commutate the motor.

To keep costs down, motors without encoders and Hall Effect sensors—referred to as “sensorless” motors—are often used. To compensate for the lack of these sensors, sensorless motors may implement algorithms that use the back electromotive force (BEMF) generated in the stator winding to determine rotor position. Other sensorless motors may use a speed observer to estimate rotor speed and position during driving. Some sensorless motors may use speed observer-based field-oriented control (FOC) or vector control algorithms without actually measuring the motor speed, position, torque, and voltage. This approach may be used in applications such as air conditioning units, ceiling fans, pumps, electric bicycles, hand dryers, wind power generators, and unmanned aerial vehicles like drones. A motor controller and inverter is often used to drive such PMSMs.

### BRIEF SUMMARY

Various examples of the present disclosure relate generally to permanent magnet synchronous motors and, in particular, to tuning a sliding mode observer to estimate rotor position and speed of a permanent magnet synchronous motor. The present disclosure includes, without limitation, the following examples.

Some examples provide a method that includes receiving an identifier of a permanent magnet synchronous motor (PMSM), and mapping the identifier to electrical parameters of the PMSM. The method may include determining one or more coefficients of a sliding mode observer (SMO) based on the electrical parameters. The method may include providing the determined coefficients to the SMO to estimate the rotor position and speed of the PMSM. In some examples, then, the determined coefficients may be used in the SMO to estimate the rotor position and speed of the PMSM.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example described herein. This disclosure is intended to be read holistically such that any separable features or elements of the disclosure, in any of its aspects and examples, may be viewed as combinable unless the context of the disclosure clearly dictates otherwise.

It will therefore be appreciated that this Brief Summary is provided merely for purposes of summarizing some examples so as to provide a basic understanding of some aspects of the disclosure. Accordingly, it will be appreciated that the above described examples are merely examples and may not be construed to narrow the scope or spirit of the disclosure in any way. Other examples, aspects and advantages will become apparent from the following detailed description taken in conjunction with the accompanying figures which illustrate, by way of example, the principles of some described examples.

### BRIEF DESCRIPTION OF THE FIGURE(S)

Having thus described examples of the disclosure in general terms, reference will now be made to the accompanying figures, which are not necessarily drawn to scale, and wherein:

FIG. 1 is a block-diagram representation of a sensorless field-oriented control (FOC) architecture, including a sliding-mode observer (SMO), for driving a permanent magnet synchronous motor (PMSM), according to some examples of the present disclosure;

FIG. 2 illustrates an example of the sensorless FOC architecture in which various components may be implemented by a controller and an inverter, according to some examples;

FIGS. 3 and 4 illustrate a switching function and a saturation function, respectively, according to some examples;

FIG. 5 illustrates a saturation function including a linear zone within a boundary layer, and behaves like a signum function outside the boundary layer, according to some examples;

FIG. 6 illustrates a configuration of a control system that may be represented by a describing function, according to some examples;

FIG. 7 illustrates the behavior of the nonlinear element under sinusoidal excitation, according to some examples;

FIG. 8 illustrates the output characteristics of the saturation nonlinearity under sinusoidal excitation, according to some examples;

FIG. 9 illustrates a configuration of a control system which have a nonlinear element represented by a describing function followed by a linear element, according to some examples, and

FIG. 10 illustrates a plant and observer model including a model of the PMSM and an internal model of the sliding-mode observer (SMO), according to some examples.

### DETAILED DESCRIPTION

Some examples of the present disclosure will now be described more fully hereinafter with reference to the accompanying figures, in which some, but not all examples of the disclosure are shown. Indeed, various examples of the disclosure may be embodied in many different forms and may not be construed as limited to the examples set forth herein; rather, these examples are provided so that this disclosure will be thorough and complete, and will fully convey the scope of the disclosure to those skilled in the art. Like reference numerals refer to like elements throughout.

Unless specified otherwise or clear from context, references to first, second, third, and so forth may not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, or geometric relationships, without limitation, unless otherwise stated, any one or more if not all of these may be approximate to account for acceptable variations that may occur, such as those due to engineering tolerances.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it may be understood that unless otherwise specified, the terms “data,” “content,” “digital content,” “information,” and similar terms may be at times used interchangeably.

Examples of the present disclosure relate to three-phase permanent magnet synchronous motors (PMSMs) driven under field-oriented control (FOC). FOC (also referred to as vector control) of motors is a control method in which the stator currents of a three-phase AC electric motor are characterized by the magnetic flux of the motor and its torque. FOC is a method by which one of the fluxes (rotor, stator, or air gap) is treated as a basis for creating a reference frame for one of the other fluxes with the purpose of decoupling the torque and flux-producing components of the stator current. Such decoupling may enable ease of control for complex three-phase motors in the same manner as DC motors with separate excitation. Armature current may be used for torque generation, and excitation current may be used for flux generation. In certain applications, the rotor flux may be considered as a reference frame for the stator and air gap flux.

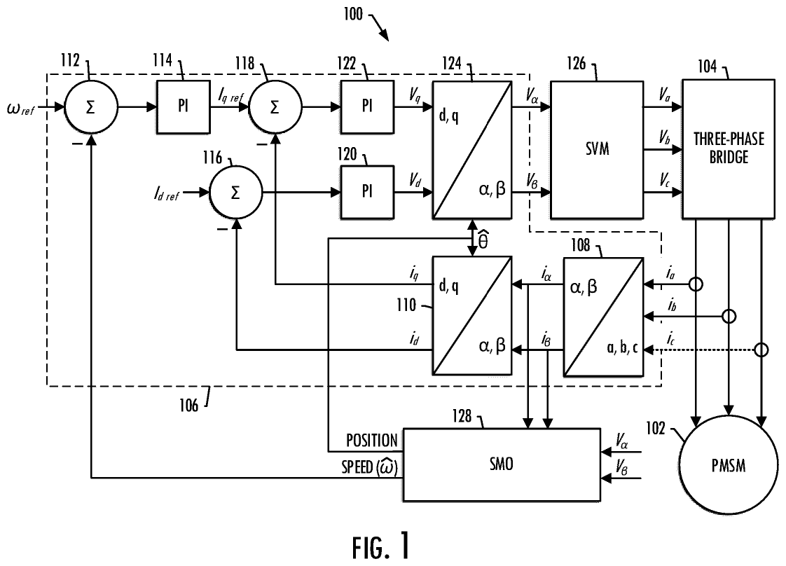

FIG. 1 is a block-diagram representation of a sensorless field-oriented control (FOC) architecture 100 for driving a permanent magnet synchronous motor (PMSM) 102, according to some examples of the present disclosure. The PMSM 102 may be any of a number of different PMSMs and their variants. According to various examples, the PMSM may be a permanent magnet synchronous motor, an interior Permanent magnet synchronous motor (IPMSM), a surface Permanent magnet, or a synchronous motor (SPMSM), without limitation.

As shown in FIG. 1, the PMSM 102 receives three-phase stator currents iₐ, i_{b}, i_{c} from a three-phase bridge 104, which may include a rectifier, an inverter, and acquisition and protection circuitry. The FOC architecture, which can be implemented using software executed by a controller, can be summarized as follows.

The sensorless FOC architecture 100 may include a FOC routine 106, which may indirectly determine and control time invariant values of torque and flux, through a series of coordinate transforms, with proportional and integral (PI) control loops. The process may include measuring the three-phase stator currents iₐ, i_{b}, i_{c}. Two of the three-phase stator currents may be measured to provide values for iₐ and i_{b}, and the value for i_{c} can be calculated using the equation iₐ+i_{b}+i_{c}=0. A first coordinate transform 108 may convert the three-phase currents iₐ, i_{b}, i_{c} from a three-axis coordinate system to a two-axis (α-β axis) coordinate system. One example of a suitable first coordinate transform is the Clarke Transform. This conversion may provide current values i_{α} and i_{β} using the measured iₐ and i_{b} values, and the calculated value i_{c}. The current values i_{α} and i_{β} may be time-varying quadrature current values as viewed from the perspective of the stator.

With the stator currents i_{α} and i_{β} represented on a two-axis orthogonal system with the α-β axis, the next operation is to transform into another two-axis system that is rotating with the rotor flux. A second coordinate transform 110 may rotate the two-axis coordinate system to align with the rotor flux using a rotor flux angle calculated at a last iteration of the control loop. This two-axis rotating coordinate system may be called the d-q axis. In the case of a PMSM, the rotor flux angle may be the same as the rotor angular position. Here, \hat{θ} represents the rotor angular position (at times more simply referred to as the rotor angle or the rotor position). One example of a suitable second coordinate transform is the Park Transform. This conversion may provide current values i_{d} and i_{q} from current values i_{α} and i_{β}. The current values i_{d} and i_{q} may be the quadrature currents transformed to the rotating coordinate system. For steady state conditions, i_{d} and i_{q} may be constant.

The FOC architecture 100 may include interdependent PI control loops for controlling three interactive variables: the rotor speed, rotor flux, and rotor torque. Specifically, one PI loop may be for controlling motor speed, and two other PI control loops may be for controlling the transformed current values i_{d} and i_{q}, which may be involved in controlling respective ones of rotor flux and rotor torque.

More specifically, a speed error signal may be formed at a summing point 112 using rotor speed \hat{ω} and a speed setpoint value ω_{ref}, and the speed error signal may be input to a PI controller. The speed error signal may be input to a first PI controller 114, and the first PI controller 114 may output a reference value i_{q ref} for i_{q}. The i_{q} reference i_{q} ref may be involved in the control of the torque output of the PMSM 102. A reference value i_{d ref} for i_{d} may be involved in the control of resultant flux.

Similar to the speed error signal, error signals for i_{d} and i_{q} may be formed at summing points 116 and 118 using i_{d} and i_{q}, along with their respective reference values i_{d ref} and i_{q ref}. The error signals may be input to second and third PI controllers 120 and 122. The second and third PI controllers may output voltage values V_{d} and V_{q}, which are voltage vectors to be sent to the PMSM 102.

The voltage values V_{d} and V_{q} are two voltage component vectors in the rotating d-q axis. Complementary inverse coordinate transforms may be used to return to the three-phase motor voltage. An inverse coordinate transform 124, such as an Inverse Park Transform, may convert voltage values V_{d} and V_{q} from the two-axis rotating d-q frame to the two-axis stationary frame α-β, and provide the next quadrature voltage values V_{α} and V_{β}. The rotor flux angle or rotor angular position \hat{θ} may also be used here. A space vector modulation (SVM) routine 126 may then be used to convert voltage values V_{α} and V_{β} from the stationary two-axis α-β frame to the stationary three-axis, three-phase reference frame of the stator, and provide voltage values Vₐ, V_{b} and V_{c}. In some examples, the Inverse Clarke Transform may be folded into the SVM routine to simplify the process. The three-phase voltage values Vₐ, V_{b} and V_{c} may be used to calculate new pulse width modulation (PWM) duty cycle values that generate a desired voltage vector.

The sensorless FOC architecture 100 for driving the PMSM 102 generally does not include corresponding sensors (such as Hall sensors, ABZ encoders, without limitation) for measuring the rotor position \hat{θ} and speed \hat{ω} (and torque). The three-phase stator currents iₐ, i_{b}, i_{c} may instead be measured using any suitable current sensor. Because rotor position and speed are used in the FOC architecture, in sensorless control modes, a speed observer may be used to estimate the rotor position and speed. One example of a speed observer is a sliding-mode observer (SMO) 128, which is an adaptive algorithm based on control theory and electrical motor mathematical modeling. In some examples, the SMO may receive the quadrature current i_{α}, i_{β} and voltage values V_{α}, V_{β} as inputs, and provide estimated rotor position \hat{θ} and speed \hat{ω} as outputs, which during subsequent control loops may converge to actual motor position and speed.

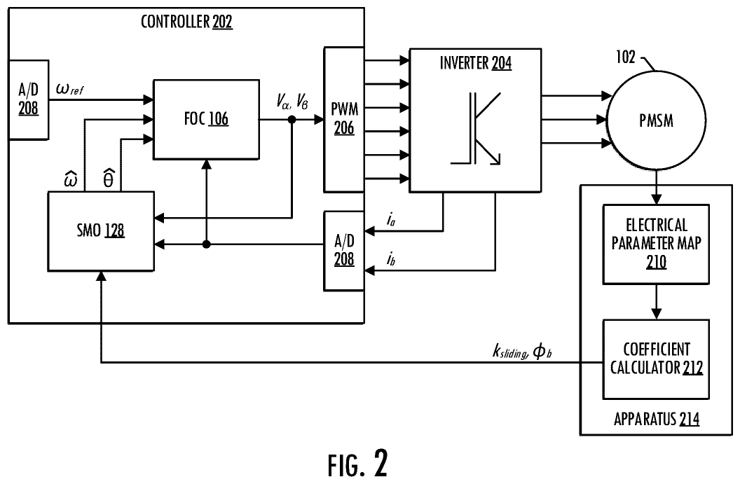

FIG. 2 illustrates an example of the sensorless FOC architecture 100 in which various components may be implemented by a controller 202 and an inverter 204. The controller may be an electronic device, such as an integrated circuit (IC). The controller includes processing circuitry, such as a general or specific-purpose processor, microprocessor, controller, or microcontroller, without limitation. The controller may provide, for example, the FOC routine 106, and a pulse width modulator 206 to implement the SVM routine 126. The controller may also implement the SMO 128. As also shown, the controller may include appropriate analog-to-digital (A/D) converters 208 to receive inputs such as current values iₐ and i_{b}, and speed setpoint value ω_{ref}.

Referring to FIGS. 1 and 2, the SMO 128 for the PMSM 102 may be described by coefficients including sliding gain k_{slide}. Traditionally using the Lyapunov stability criteria, the gain k_{slide} is chosen positive. However, there is no mention of how big or small this k_{slide} will be for a particular system. It has been observed that one gain which works for one PMSM does not work for others; and accordingly, the k_{slide} is often chosen by hit and trial. As also explained in greater detail below, examples of the SMO with a saturation function instead of a sign function creates added complexity in that the SMO is further described by a boundary layer width ϕ_{b} that may be determined. Examples of the present disclosure therefore provide a technique for tuning the SMO, and in particular the sliding gain k_{slide} and boundary layer width ϕ_{b}. The technique may reduce design time and increase efficiency and reliability of a SMO-based sensorless FOC architecture 100.

As shown in FIG. 2 (but also equally applicable to FIG. 1), some examples may include an electrical parameter map 210 to receive an identifier of the PMSM 102, such as a model number or part number, and map the identifier to electrical parameters of the PMSM. The electrical parameters may be provided to a coefficient calculator 212 to calculate or otherwise determine SMO coefficients, including sliding gain k_{slide} and boundary layer width ϕ_{b}, based on the electrical parameters. The SMO coefficients may then be provided to the SMO 128 for use to estimate the rotor position \hat{θ} and speed \hat{ω}. In some examples, the electrical parameter map and coefficient calculator are provided by a separate apparatus 214, such as a computer or other apparatus including appropriate processing circuitry, and loaded onto the controller 202. In other examples, the electrical parameter map and coefficient calculator may be provided onboard the controller.

To further describe the SMO 128, the dynamic model of the PMSM 102 in the α-β domain can be expressed as follows:

$$\frac{d}{dt} ( {i}_{α s} ) = - \frac{R}{L} {i}_{α s} + \frac{1}{L} ( {v}_{α s} - {e}_{α s} ) \qquad ( 1 a )$$

$$\frac{d}{dt} ( {i}_{β s} ) = - \frac{R}{L} {i}_{β s} + \frac{1}{L} ( {v}_{β s} - {e}_{β s} ) \qquad ( 1 b )$$

Based on the above dynamic model an observer model can be defined as:

$$\frac{d}{dt} ( {\hat{i}}_{α s} ) = - \frac{R}{L} {\hat{i}}_{α s} + \frac{1}{L} ( {v}_{α s} - {\hat{e}}_{α s} - {z}_{α} ) \qquad ( 2 a )$$

$$\frac{d}{dt} ( {\hat{i}}_{β s} ) = - \frac{R}{L} {\hat{i}}_{β s} + \frac{1}{L} ( {v}_{β s} - {\hat{e}}_{β s} - {z}_{β} ) \qquad ( 2 b )$$

where î_{αs}, î_{βs}, ê_{αs} and ê_{βs} are the estimated quantities, and z_{α}, z_{β} are defined as follows:

$${z}_{α} = {k}_{α} sign ( {\hat{i}}_{α s} ) \qquad ( 3 a )$$

$${z}_{β} = {k}_{β} sign ( {\hat{i}}_{β s} ) \qquad ( 3 b )$$

where ĩ_{αs}=(î_{αs}−i_{αs}), ĩ_{βs}=(î_{βs}−i_{βs}) are the estimation errors and sign(ĩ_{αs})=0, sign(ĩ_{βs})=0 are the switching surfaces.

The error dynamics can be expressed as follows:

$$\frac{d}{dt} ( {\tilde{i}}_{α s} ) = \frac{d}{dt} ( {\hat{i}}_{α s} ) - \frac{d}{dt} ( {i}_{α s} ) = - \frac{R}{L} {\hat{i}}_{α s} + \frac{1}{L} ( {v}_{α s} - {\hat{e}}_{α s} - {z}_{α} ) + \frac{R}{L} {i}_{α s} - \frac{1}{L} ( {v}_{α s} - {e}_{α s} ) \qquad ( 4 a )$$

$$\frac{d}{dt} ( {\tilde{i}}_{α s} ) = \frac{d}{dt} ( {\hat{i}}_{β s} ) - \frac{d}{dt} ( {i}_{β s} ) = - \frac{R}{L} {\hat{i}}_{β s} + \frac{1}{L} ( {v}_{β s} - {\hat{e}}_{β s} - {z}_{β} ) + \frac{R}{L} {i}_{β s} - \frac{1}{L} ( {v}_{β s} - {e}_{β s} ) \qquad ( 4 b )$$

The above expressions reduce to:

$$\frac{d}{dt} ( {\tilde{i}}_{α s} ) = - \frac{R}{L} {\tilde{i}}_{α s} - \frac{1}{L} {\tilde{e}}_{α s} - \frac{1}{L} {z}_{α} \qquad ( 5 a )$$

$$\frac{d}{dt} ( {\tilde{i}}_{β s} ) = - \frac{R}{L} {\tilde{i}}_{β s} - \frac{1}{L} {\tilde{e}}_{β s} - \frac{1}{L} {z}_{β} \qquad ( 5 b )$$

where \tilde{e}_{αs}, \tilde{e}_{βs} are the back electromotive force (BEMF) estimation errors.

To derive a sliding gain (k) formulation through the Lyapunov approach, a positive definite Lyapunov function V>0 may be chosen, subjected to dynamics defined by equation (5):

$$V = \frac{1}{2} ( {\tilde{i}}_{α s}^{2} + {\tilde{i}}_{β s}^{2} ) \qquad ( 6 )$$

According to the Lyapunov criteria for stability, the time derivative of V, i.e., \dot{V}≤(−ηₐ|ĩ_{αs}|−η_{β}|ĩ_{βs}|), where η_{α}, η_{β}>0. The time derivative of equation (6) can be expressed as follows:

$$\dot{V} = {\tilde{i}}_{α s} \frac{d}{dt} ( {\tilde{i}}_{α s} ) + {\tilde{i}}_{β s} \frac{d}{dt} ( {\tilde{i}}_{β s} ) \qquad ( 7 )$$

Replacing equation (5) into equation (7), equation (7) can be further expressed as

$$\dot{V} = {\tilde{i}}_{α s} \{ - \frac{R}{L} {\tilde{i}}_{α s} - \frac{1}{L} {\tilde{e}}_{α s} - \frac{1}{L} {k}_{α} sign ( {\tilde{i}}_{α s} ) \} + {\tilde{i}}_{β s} \{ - \frac{R}{L} {\tilde{i}}_{β s} - \frac{1}{L} {\tilde{e}}_{β s} - \frac{1}{L} {k}_{β} sign ( {\tilde{i}}_{β s} ) \} \qquad ( 8 )$$

Equation (8) can be further reduced to:

$$\dot{V} = - \frac{R}{L} \vert {\tilde{i}}_{α s} \vert - \frac{1}{L} {\tilde{e}}_{α s} {\tilde{i}}_{α s} - \frac{1}{L} {k}_{α} \vert {\tilde{i}}_{α s} \vert - \frac{R}{L} \vert {\tilde{i}}_{β s} \vert - \frac{1}{L} {\tilde{e}}_{β s} {\tilde{i}}_{β s} - \frac{1}{L} {k}_{β} \vert {\tilde{i}}_{β s} \vert \qquad ( 9 )$$

Now to satisfy the stability condition, the following expressions may be individually less than zero, i.e.,

$$- \frac{1}{L} {\tilde{e}}_{α s} {\tilde{i}}_{α s} - \frac{1}{L} {k}_{α} \vert {\tilde{i}}_{α s} \vert < 0 and \\ - \frac{1}{L} {\tilde{e}}_{β s} {\tilde{i}}_{β s} - \frac{1}{L} {k}_{β} \vert {\tilde{i}}_{β s} \vert < 0 ( since - \frac{R}{L} \vert {\tilde{i}}_{α s} \vert and - \frac{R}{L} \vert {i}_{β s} \vert$$

are already negative). Therefore, if k_{α}>|\tilde{e}_{αs}| and k_{β}>|\tilde{e}_{βs}|, then the stability condition will be satisfied. These inequalities can be further represented as the sliding gains:

$${k}_{α} = {η}_{α} + \vert {\tilde{e}}_{α s} \vert \qquad ( 10 a )$$

$${k}_{β} = {η}_{β} + \vert {\tilde{e}}_{β s} \vert \qquad ( 10 b )$$

Putting equation (10) into equation (9), equation (9) can be further expressed as:

$$\dot{V} = - \frac{R}{L} \vert {\tilde{i}}_{α s} \vert - \frac{1}{L} {\tilde{e}}_{α s} {\tilde{i}}_{α s} - \frac{1}{L} ( {η}_{α} + \vert {\tilde{e}}_{α s} \vert ) \vert {\tilde{i}}_{α s} \vert - \frac{R}{L} \vert {\tilde{i}}_{β s} \vert - \frac{1}{L} {\tilde{e}}_{β s} {\tilde{i}}_{β s} - \frac{1}{L} ( {η}_{β} + \vert {\tilde{e}}_{β s} \vert ) \vert {\tilde{i}}_{β s} \vert \qquad ( 11 )$$

Notably, the terms

$$- \frac{1}{L} {\tilde{e}}_{α s} {\tilde{i}}_{α s} , - \frac{1}{L} {\tilde{e}}_{β s} {\tilde{i}}_{β s}$$

can either be positive or negative, depending on the sign of the estimation errors of current and BEMF. If these terms are positive, then they may cancel the terms

$$- \frac{1}{L} \vert {\tilde{e}}_{α s} \vert \vert {\tilde{i}}_{α s} \vert and - \frac{1}{L} \vert {\tilde{e}}_{β s} \vert \vert {\tilde{i}}_{β s} \vert ,$$

and what left is

$$\dot{V} = - \frac{R}{L} \vert {\tilde{ι}}_{α s} \vert - \frac{1}{L} {η}_{α} \vert {\tilde{ι}}_{α s} \vert - \frac{R}{L} \vert {\tilde{ι}}_{β s} \vert - \frac{1}{L} {η}_{α} \vert {\tilde{ι}}_{α s} \vert .$$

If the terms

$$( - \frac{1}{L} {\tilde{e}}_{a s} {\tilde{ι}}_{α s} , - \frac{1}{L} {\tilde{e}}_{β s} {\tilde{ι}}_{β s} )$$

are negative, then it may negatively add up to the rest of the terms, which may produce a more negative value. Hence, for both conditions, \dot{V} remains less than (−η_{α}|ĩ_{αs}|−η_{β}|ĩ_{βs}|).

It may therefore be said that the system may be stable for the above sliding gains (k_{α}, k_{β}). However, \tilde{e}_{αs} and \tilde{e}_{βs} are unknown, so a sufficiently large positive value for both the sliding gains (k_{α}, k_{β}>max (|e_{αs}|, |e_{βs}|)) may be chosen so that equations (10a) and (10b) can be satisfied. The value can be estimated from the operating voltage and lock in RPM. Further, the voltage constant (also referred to as the BEMF constant) may be known, and from the voltage constant of the motor, the value of k_{α}, k_{β} may be chosen. As described herein, either sliding gain k_{α} or k_{β} may be referred to as sliding gain k_{slide}.

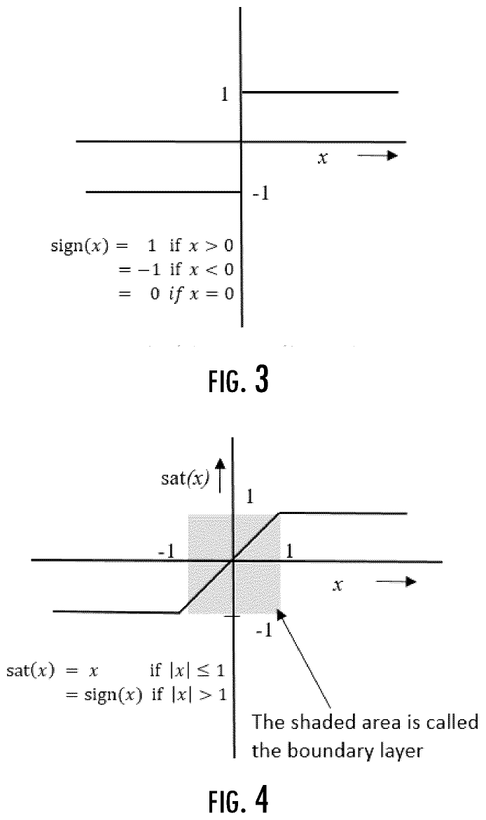

The above formulation considers the example of switching functions in the form of sign(ĩ_{αs}) and sign(ĩ_{βs}). This type of example, however, may experience chattering. To reduce the chattering effect of the sliding mode, a saturation function may instead be implemented. The difference between these two functions is shown in FIGS. 3 and 4, which illustrate a switching function and a saturation function, respectively.

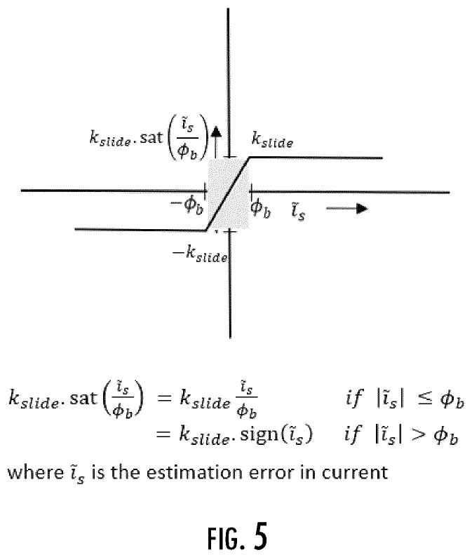

The gain selection of the SMO 128 may be difficult to perform, especially when switching nonlinearity is replaced with saturation nonlinearity, as the saturation function has a linear zone (within boundary layer); and outside boundary layer, the saturation function behaves like a signum function, as shown in FIG. 5.

As shown in FIG. 5, the saturation function may be described by the sliding gain k_{slide} (or more simply k) and a boundary layer width ϕ_{b} (or more simply ϕ). The values of k and ϕ in the saturation function decide the area of the boundary layer. The slope

$$\frac{k}{ϕ}$$

decides now aggressive is the actuation, the steeper the slope, the aggressiveness is more. The steepness can be increased or decreased by changing the values of either k, ϕ or both. If k is chosen large, then ϕ may be also larger in order to restrict the linear gain. If ϕ is chosen very small, then the boundary layer on the horizontal axis is very small and the example is closer to the sign function and chattering may be increased. If ϕ is taken too large, chattering can be reduced, however, the accuracy of estimation may be compromised.

After choosing k through Lyapunov approach, ϕ may be chosen. For this, a describing function-based approach may be considered. This method is also referred to as Harmonic Balance (HB) method. It is a mathematical approach that may be used to analyze specific set of nonlinear close loop system. It may be characterized as a union of a static nonlinearity with a linear system. The describing function method may be a fairly accurate technique to describe the amplitude and frequency of oscillations in the system's output via the first-harmonic component, under the assumption of a periodic steady-state response in systems with a linear component exhibiting low-pass filter like characteristics.

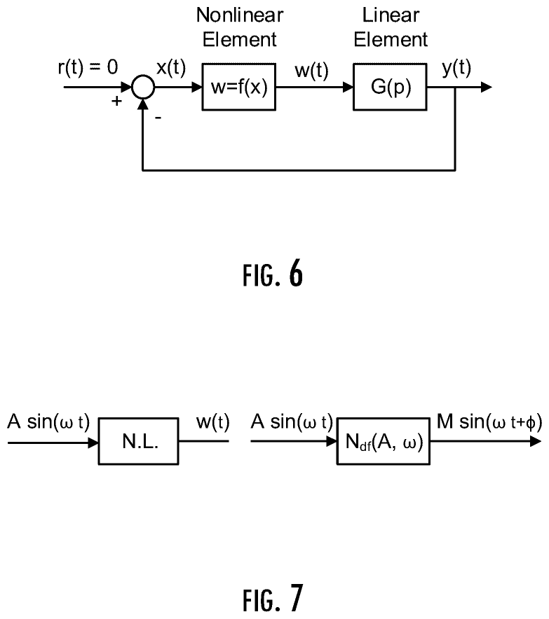

Any control system that can be converted into the system structure depicted in FIG. 6 may be analyzed using the describing function technique. The first assumption is that the control system includes a single nonlinear component, and the second assumption is that it is a time-invariant system. The third assumption is that if a sinusoidal input is applied to the system, only the fundamental component may be considered in the system's output. The fourth assumption is that the nonlinearity is odd.

The third assumption of the describing function method. It represents a ballpark estimation, since the output of a nonlinear element in response to a sinusoidal input typically includes higher-order harmonics in addition to the fundamental frequency. In contrast to the fundamental component, this assumption suggests that all the higher-order harmonics can be ignored in the analysis. The linear component that follows the nonlinearity must possess low-pass characteristics for this assumption to be true, i.e., |G(jω)|>>|G(jnω)| for n=2, 3, . . . .

As seen in FIG. 7, a sinusoidal input to the nonlinear component with amplitude A and frequency ω, meaning x(t)=A sin(ωt), may be used to demonstrate the representation of a nonlinear component by a describing function method. In response to the sinusoidal input, the nonlinear component w(t) generally produces a periodic function that is typically non-sinusoidal. Nonetheless, the nonlinear block's output may be characterized as follows:

$$w ( t ) = \frac{{a}_{0}}{2} + {\sum }_{n = 1}^{∞} [ {a}_{n} cos ( n ω t ) + {b}_{n} sin ( n ω t ) ] \qquad ( 12 )$$

$$where ,$$

$${a}_{0} = \frac{1}{π} {\int }_{- π}^{π} w ( t ) d ( wt )$$

$${a}_{n} = \frac{1}{π} {\int }_{- π}^{π} w ( t ) cos ( n ω t ) d ( wt )$$

$${b}_{n} = \frac{1}{π} {\int }_{- π}^{π} w ( t ) sin ( n ω t ) d ( wt )$$

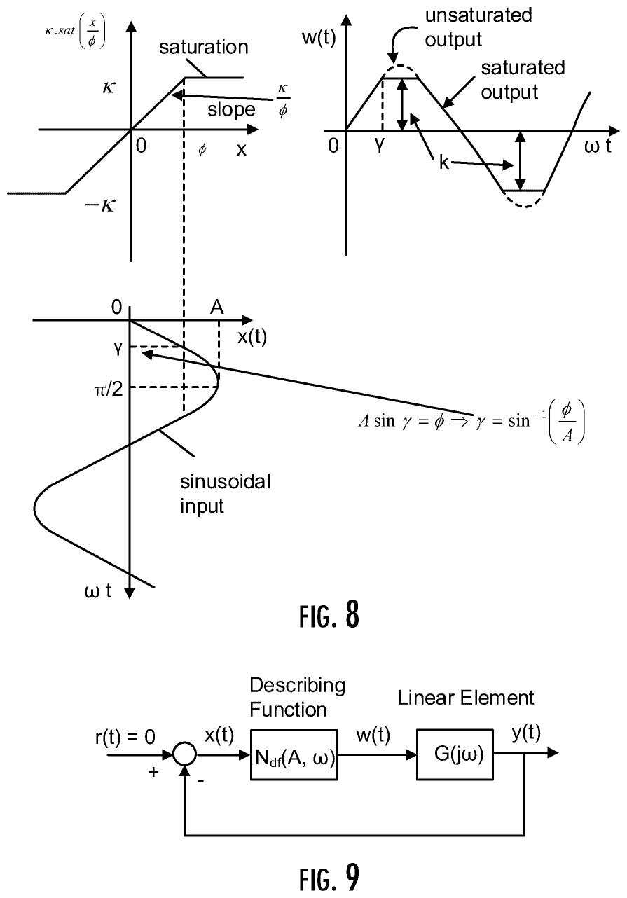

To illustrate the describing function for the saturation nonlinearity, FIG. 8 illustrates the output characteristics of the saturation nonlinearity under sinusoidal excitation. If x(t)=A sin ωt is applied to the saturation nonlinearity, one may end up with the following output signal:

$$w ( t ) = \{ \begin{matrix}\frac{kA}{ϕ} sin ω t & 0 \leq ω t \leq γ \\ k & γ < ω t \leq \frac{π}{2}\end{matrix} \qquad ( 13 )$$

Considering the odd nature of the nonlinearity, only b₁ needs to be considered and only the fundamental component is taken into account considering the third assumption. Hence the expression for b₁ can be written as:

$${b}_{1} = \frac{1}{π} {\int }_{- π}^{π} w ( t ) sin ( ω t ) d ( wt ) = \frac{2}{π} {\int }_{0}^{π} w ( t ) sin ( ω t ) d ( wt ) = \frac{4}{π} {\int }_{0}^{\frac{π}{2}} w ( t ) sin ( ω t ) d ( wt ) \qquad ( 14 )$$

Replacing w(t) in equation (14) yields:

$${b}_{1} = \frac{4}{π} [ {\int }_{0}^{γ} \frac{kA}{ϕ} {sin}^{2} ω t d ( wt ) + {\int }_{γ}^{\frac{π}{2}} k sin ω t d ( wt ) ] \qquad ( 15 )$$

Equation (15) may be simplified to:

$${b}_{1} = \frac{2 kA}{π ϕ} [ γ - sin γ cos γ + \frac{2 ϕ}{A} cos γ ] = \frac{2 kA}{π ϕ} [ γ + \frac{ϕ}{A} cos γ ] = \frac{2 kA}{π ϕ} [ γ + \frac{ϕ}{A} \sqrt{1 - \frac{{ϕ}^{2}}{{A}^{2}}} ] \qquad ( 16 )$$

The describing function for the saturation nonlinearity may therefore be written as:

$${N}_{df} ( A , ϕ , k ) = \frac{{b}_{1}}{A} = \{ \begin{matrix}\frac{2 k}{π ϕ} [ {sin}^{- 1} ( \frac{ϕ}{A} ) + \frac{ϕ}{A} \sqrt{1 - \frac{{ϕ}^{2}}{{A}^{2}}} ] & for 0 \leq ϕ \leq A \\ \frac{k}{ϕ} & for ϕ > A\end{matrix} \qquad ( 17 )$$

Further, it can be noted that:

$${lim}_{ϕ \to {0}^{+}} {N}_{df} ( A , ϕ , k ) = \frac{4 k}{π A} \qquad ( 18 )$$

$$and$$

$${lim}_{ϕ \to {A}^{-}} {N}_{df} ( A , ϕ , k ) = \frac{k}{A} = {N}_{df} ( A , ϕ , k ) {\vert}_{ϕ = A} \qquad ( 19 )$$

Assume that the control system is experiencing a self-sustaining oscillation with amplitude A and frequency ω. The following relations are satisfied by the variables in the loop (see FIG. 9):

$$x = - y , w = {N}_{df} ( A , ω ) x , y = G ( j ω ) w \qquad ( 20 )$$

One may therefore have y=G(jω)N_{df}(A, ω)(−y). Because y≠0, this implies:

$$G ( j ω ) {N}_{df} ( A , ω ) + 1 = 0 \qquad ( 21 )$$

Equation (21) can be further rewritten as:

$$G ( j ω ) = - \frac{1}{{N}_{df} ( A , ω )} \qquad ( 22 )$$

Equation (22) is satisfied by the frequency ω and amplitude A of the limit cycles in the control system. The nonlinear system doesn't have limit cycles if the equation (22) contains no solutions. It represents two nonlinear equations containing variables A and ω (one is given by the real and the other one is given by the imaginary parts), and there are often only a limited number of solutions available.

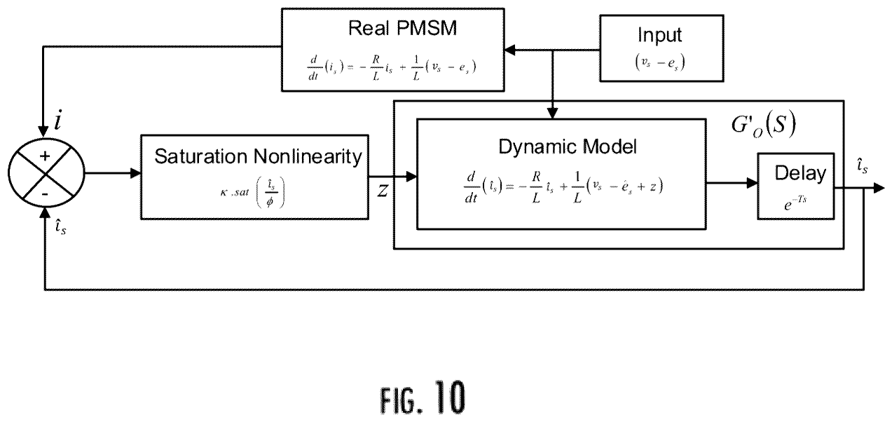

Treat the observer as a dynamical system with two inputs and a single output. It helps to find out the transfer function (TF) for the internal model of the observer. The observer output îₛ must follow (track) one of the two inputs iₛ. It is possible to treat the other input (vₛ−eₛ) as a feedforward. The observer may therefore be considered a feedback-feedforward system that employs the sliding-mode algorithm in the controller. FIG. 10 is a plant and observer model including a model of the PMSM 102 and an internal model of the SMO 128, according to some examples.

As shown in FIG. 10, the expression for the transfer function of the internal model of the SMO 128 may be as follows

$${G}_{o} ( s ) = \frac{1}{Ls + R} .$$

The total TF with the delay is

$${G}_{o}^{′} ( s ) = \frac{{e}^{- Ts}}{Ls + R} .$$

However, instead of (vₛ−eₛ), one may have (vₛ−êₛ), where êₛ is an estimated value. This delay e^{-Ts}, may be called the equivalent delay, which may be determined via matching the frequency of chattering in the original discrete-time system and the equivalent continuous-time system with the delay. An equivalent delay of two sampling period is considered for the present analysis.

Given the TF of the observer,

$${G}_{o}^{′} ( s ) = \frac{{e}^{- Ts}}{Ls + R} ,$$

Pade's first order approximation may be applied to produce:

$${G}_{o}^{′} ( j ω ) = \frac{1}{j ω L + R} \times \frac{2 - j ω T}{2 + j ω T} \qquad ( 23 )$$

Equation (23) may therefore be rewritten as:

$$\frac{1}{{G}_{o}^{′} ( j ω )} = \frac{( 2 + j ω T ) ( j ω L + R )}{2 - j ω T} \qquad ( 24 )$$

Segregating the complex and real terms in turn produces:

$$- {{G}_{o}^{′} ( j ω )}^{- 1} = \frac{j ω [ - 4 L - 4 RT + {L ( ω T )}^{2} ] - 4 R + 4 {ω}^{2} LT + {R ( ω T )}^{2}}{4 + {( ω T )}^{2}} = {N}_{df} ( A , ω ) \qquad ( 25 )$$

The describing function of the saturation nonlinearity is known and given by equation (17). Furthermore, the amplitude of the oscillation A reduces as the parameter ϕ grows, as seen by the fact that N_{df}(A, ϕ) is monotonically decreasing regarding both the arguments. Then using ϕ=A, the minimum magnitude A in the domain of ϕ can be found, and in that case the describing function can be expressed as equation (19), i.e.,

$${N}_{df} = \frac{k}{A} .$$

As can be seen from equations (17), (18) and (19), the saturation nonlinearity has no complex term so from equation (25), the expression for the ω can be rewritten:

$$\frac{j ω [ - 4 L - 4 RT + {L ( ω T )}^{2} ]}{4 + {( ω T )}^{2}} = 0 ⇒ ω = \frac{2}{T} \sqrt{\frac{L + RT}{L}} \qquad ( 26 )$$

In the limiting case given by equation (19), then, the value of amplitude A is minimum and may be expressed as:

$$\frac{k}{A} = \frac{- 4 R + 4 {ω}^{2} LT + {R ( ω T )}^{2}}{4 + {( ω T )}^{2}} ⇒ A = \frac{k [ 4 + {( ω T )}^{2} ]}{- 4 R + 4 {ω}^{2} LT + {R ( ω T )}^{2}} = ϕ \qquad ( 27 )$$

Putting the value of the angular frequency from equation (26) in equation (27), the amplitude can be further expressed as:

$$A = \frac{k [ 4 + {( ω T )}^{2} ]}{- 4 R + 4 {ω}^{2} LT + {R ( ω T )}^{2}} = \frac{k [ 1 + \frac{( L + RT )}{L} ]}{- R + \frac{4 ( L + RT )}{T} + R \frac{( L + RT )}{L}} = ϕ \qquad ( 28 )$$

According to some examples of the present disclosure, then, from the BEMF constant and locking RPM, a sliding gain k may be chosen for the PMSM 102. In some examples, the sliding gain k may be chosen two to three times of the BEMF constant at the locking RPM. The boundary layer width ϕ may be calculated using equation (28), and the motor electrical parameters for inductance L and resistance R, as well as equivalent delay time T which is two times the sampling time T_{S}. The slope (linear gain)

$$\frac{k}{ϕ}$$

may inen be calculated.

To further illustrate some examples, consider a long Hurst motor. Assume the voltage constant for the long Hurst motor is given as 7.34 V line-to-line peak/kRPM; and that the phase-to-neutral is therefore 4.23 V/KRPM. If the locking RPM is 500, then at that RPM, the voltage constant will be 2.115 V. In this example, the sliding gain k may be chosen 2-to-3 times the voltage constant, such as k=4.5, as the error on BEMF estimation will be no greater than this value at that RPM.

Taking the long hurst motor electrical parameters for inductance L and resistance R, the sampling time T_{S}, and the sliding gain k, the amplitude boundary layer width ϕ can be calculated according to equation (28) as:

$$A = ϕ = \frac{k [ 1 + \frac{( L + RT )}{L} ]}{- R + \frac{4 ( L + RT )}{T} + R \frac{( L + RT )}{L}} ≅ 0.747$$

where T=2×Tₛ=0.0001, L=2.87×10⁻⁴ H, R=0.285Ω, k=4.5. The linear gain may then be calculated as

$$\frac{k}{ϕ} = 6.02 .$$

Next, consider a short Hurst motor. Assume the voltage constant for the short hurst motor is given as 7.24 V line-to-line peak/kRPM; and that the phase-to-neutral is therefore 4.18 V/KRPM. If the locking RPM is 500, then at that RPM, the voltage constant will be 2.09 V. In this example, the sliding gain k may be chosen 2-to-3 times the voltage constant, such as k=4.18, as the error on BEMF estimation will be no greater than this value at that RPM. The amplitude boundary layer width ϕ can be calculated from equation (28) using the short hurst motor electrical parameters, the sampling time, and the sliding gain k:

$$A = ϕ = \frac{k [ 1 + \frac{( L + RT )}{L} ]}{- R + \frac{4 ( L + RT )}{T} + R \frac{( L + RT )}{L}} ≅ 0.0815$$

where T=2×Tₛ=0.0001, L=0.002423 H, R=2.8Ω, k=4.18. The linear gain may then be calculated as

$$\frac{k}{ϕ} = 51.26 .$$

Now consider a linix motor. Assume the voltage constant for the linix motor is given as 2.97 V line-to-line peak/kRPM; and that the phase-to-neutral is therefore 1.715 V/KRPM. If the locking RPM is 1000, then at that RPM, the voltage constant will be 1.715 V. In this example, the sliding gain k may be chosen 2-to-3 times the voltage constant, such as k=3.432. The amplitude boundary layer width ϕ can be calculated by equation (28) using the linix motor electrical parameters, the sampling time, and the sliding gain k:

$$A = ϕ = \frac{k [ 1 + \frac{( L + RT )}{L} ]}{- R + \frac{4 ( L + RT )}{T} + R \frac{( L + RT )}{L}} ≅ 0.4096$$

where T=2×Tₛ=0.0001, L=0.0003905 H, R=0.569240Ω, k=3.432. The linear gain may then be calculated as

$$\frac{k}{ϕ} = 8.392 .$$

Notably, since une unix motor has greater saliency, the dynamic model of the observer used for linix may be different from the dynamic model used for the long and short Hurst.

Many modifications and other examples of the disclosure set forth herein will come to mind to one skilled in the art to which the disclosure pertains having the benefit of the teachings presented in the foregoing description and the associated figures. Therefore, it is to be understood that the disclosure is not to be limited to the specific examples disclosed and that modifications and other examples are intended to be included within the scope of the appended claims. Moreover, although the foregoing description and the associated figures describe examples in the context of certain example combinations of elements or functions, it may be appreciated that different combinations of elements or functions may be provided by alternative examples without departing from the scope of the appended claims. In this regard, for example, different combinations of elements or functions than those explicitly described above are also contemplated as may be set forth in some of the appended claims. Although specific terms are employed herein, they are used in a generic and descriptive sense and not for purposes of limitation.

What is claimed is:

1. An apparatus comprising:
at least one memory configured to store instructions; and
at least one processing circuitry configured to access the at least one memory, and execute the instructions to cause the apparatus to at least:
receive an identifier of a permanent magnet synchronous motor (PMSM);
map the identifier to electrical parameters of the PMSM;
determine one or more coefficients of a sliding mode observer (SMO) based on the electrical parameters; and
provide the determined one or more coefficients to the SMO to estimate at least one of position and speed of a rotor of the PMSM.

2. The apparatus of claim 1, wherein the identifier of the PMSM is a model number or a part number.

3. The apparatus of claim 1, wherein an electrical parameter map is configured to receive the identifier of the PMSM and map the identifier to electrical parameters of the PMSM, and the electrical parameters of the PMSM are provided to a coefficient calculator configured to determine the one or more coefficients of the SMO.

4. The apparatus of claim 3, wherein the electrical parameter map and the coefficient calculator are provided by a separate apparatus and loaded onto a controller.

5. The apparatus of claim 1, wherein the electrical parameters of the PMSM include resistance, inductance, and a back electromotive force (BEMF) constant.

6. The apparatus of claim 1, wherein the one or more coefficients of the SMO include a sliding gain and a boundary layer width.

7. The apparatus of claim 6, wherein the sliding gain is chosen through a Lyapunov approach, and the boundary layer width is subsequently chosen through a Harmonic Balance (HB) method.

8. The apparatus of claim 6, wherein the sliding gain is chosen based on the BEMF constant and a locking RPM, and the boundary layer width is calculated using amplitude, the electrical parameters of the PMSM for inductance and resistance, and equivalent delay time.

9. The apparatus of claim 8, wherein the sliding gain is chosen approximately two to three times of the BEMF constant at the locking RPM, and the equivalent time delay is approximately two times a sampling time.

10. The apparatus of claim 6, wherein a linear gain is calculated using a ratio between the sliding gain and the boundary layer width, and corresponds to a slope in a saturation function described by the sliding gain and the boundary layer width.

11. A method comprising:
receiving an identifier of a permanent magnet synchronous motor (PMSM);
mapping the identifier to electrical parameters of the PMSM;
determining one or more coefficients of a sliding mode observer (SMO) based on the electrical parameters; and
providing the determined one or more coefficients to the SMO to estimate at least one of position and speed of a rotor of the PMSM.

12. The method of claim 11, wherein the identifier of the PMSM is a model number or a part number.

13. The method of claim 11, wherein an electrical map parameter is configured to receive the identifier of the PMSM and map the identifier to electrical parameters of the PMSM, and the electrical parameters of the PMSM are provided to a coefficient calculator configured to determine the one or more coefficients of the SMO.

14. The method of claim 13, wherein the electrical parameter map and the coefficient calculator are provided by a separate apparatus and loaded onto a controller.

15. The method of claim 11, wherein the electrical parameters of the PMSM include resistance, inductance, and a back electromotive force (BEMF) constant.

16. The method of claim 11, wherein the one or more coefficients of the SMO include a sliding gain and a boundary layer width.

17. The method of claim 16, wherein the sliding gain is chosen through a Lyapunov approach, and the boundary layer width is subsequently chosen through a Harmonic Balance (HB) method.

18. The method of claim 16, wherein the sliding gain is chosen based on the BEMF constant and a locking RPM, and the boundary layer width is calculated using amplitude, the electrical parameters of the PMSM for inductance and resistance, and equivalent time delay.

19. The method of claim 18, wherein the sliding gain is chosen approximately two to three times of the BEMF constant at the locking RPM, and the equivalent time delay is approximately two times a sampling time.

20. The method of claim 16, wherein a linear gain is calculated using a ratio between the sliding gain and the boundary layer width, and corresponds to a slope in a saturation function described by the sliding gain and the boundary layer width.
